(19) United States
(12) Patent Application Publication
(10) Pub. No.: US 2010/0130692 A1
(43) Pub. Date: May 27, 2010

(54) ETHYLENE-BASED POLYMER COMPOSITIONS, METHODS OF MAKING THE SAME, AND ARTICLES PREPARED THEREFROM

(76) Inventors: Pak-Meng Cham, Lake Jackson, TX (US); Detlef Schramm, Waedenswil (CH); Patrik J.C Schouterden, Wachtebeke (BE)

Correspondence Address: The Dow Chemical Company, Intellectual Property Section, P.O. Box 1967, Midland, MI, 48641-1967, US

(21) Appl. No.: 12/598,546

(22) PCT Filed: May 7, 2008
(86) PCT No.: PCT/US08/62848

§ 371 Date: Jan. 28, 2010

Related U.S. Application Data
(60) Provisional application No. 60/916,938, filed on May 9, 2007.

(51) Int. Cl. C08L 23/04

(52) U.S. Cl. 525/240

(57) ABSTRACT

The invention provides a composition, comprising at least one high molecular weight ethylene-based interpolymer, and at least one low molecular weight ethylene-based interpolymer, and where the high molecular weight ethylene-based interpolymer has a density less than, or equal to, 0.960 g/cc, and a melt index (I5) less than, or equal to, 1.0 g/10 min; and where the low molecular weight ethylene-based interpolymer has a density less than, or equal to, 0.915 g/cc, and a melt index (I2) greater than, or equal to, 0.4 g/10 min.

The present invention provides ethylene-based polymer compositions, articles prepared from the same and methods of making the same. The compositions of the invention are particularly suitable for use in films and geomembranes.

Films and geomembranes, fabricated by blown film processes, require high melt strength for bubble stability. This is a challenging problem, as other performance requirements often require that the final articles produced, have a relatively high thickness (gauge), which, in turn, makes it difficult to process the precursor resin using blown film processes. The produced articles typically must meet other performance requirement, such as high stress crack resistance, high impact toughness, and good tensile properties.

International Publication No. WO 02/055600 discloses a blend comprising a high molecular weight, medium density polyethylene (HMW, MDPE) and a linear low density polyethylene (LLDPE). The blend comprises from about 20 weight percent to about 80 weight percent of the HMW MDPE. The HMW MDPE has a density from about 0.92 to about 0.944 g/cc, a melt index MI2 from about 0.01 to about 0.5 dg/min, and a melt flow ratio MFR from about 50 to about 300. The blend also comprises about 20 weight percent to about 80 weight percent of the LLDPE. The LLDPE has a density within the range of about 0.90 to about 0.925 g/cc and an MI2 within the range of about 0.50 to about 50 dg/min.

U.S. Pat. No. 5,338,589 discloses a polyethylene molding composition, which consists of 50 to 80 percent, by weight, of a high density polyethylene having a very broad bimodal molecular mass distribution, and 20 to 50 percent, by weight, of a linear low density polyethylene or low density polyethylene. The composition is disclosed as used for pipes, plates and sheets, which have very good long-term and low-temperature characteristics.

International Publication No. WO 03/099922 discloses a blend comprising a high molecular weight, high density polyethylene (HMW HDPE), and a linear low density polyethylene (LLDPE). The blend comprises from about 50 weight percent to about 80 weight percent of HMW HDPE. The HMW HDPE has a density greater than about 0.94 g/cc, and a melt index MI2 less than about 0.1 dg/min. The blend also comprises about 20 weight percent to about 50 weight percent of the LLDPE. The LLDPE has a density within the range of about 0.90 to about 0.93 g/cc and an MI2 within the range of about 0.5 to about 5 dg/min. The LLDPE is a copolymer of ethylene with 1-hexene that has a dart drop impact strength of greater than about 500 grams as measured by ASTM D1709/A.

International Publication No. WO96/35750 discloses medium modulus molded polyethylene materials with improved impact strength. The molded material comprises a high molecular weight, linear polyethylene, and a substantially linear ethylene/alpha-olefin interpolymer. The material has a density in the range of 0.923 to 0.95 grams/cubic centimeter (g/cc), and has an excellent impact resistance.

EP 0797622B1 discloses compositions comprising high molecular weight, high density polyethylenes (HMW-HDPE) combined with a second component, such as styrene-butadiene-styrene, styrene-isoprene-styrene, EPR, EPDM, butyl rubber, metallocene-calatyzed linear low density polyethylene, and combinations thereof. The second component or components are present from 1 to 15 weight percent.

International Publication No. WO 01/98409 discloses blends of a very low density polyethylene, produced using metallocene catalysts (mVLDPE), and a high density polyethylene (HDPE). The metallocene-catalyzed VLDPE polymer has a density of less than 0.916 g/cc, and is preferably linear, without long chain branching. The HDPE polymer has a density greater than 0.940 g/cc. The polymer blends are disclosed as suitable in blown and cast film applications.

International Publication No. WO 03/085044 discloses a polyethylene composition comprising a melt blend of the following; (i) a bimodal, high molecular weight, high density polyethylene resin having a NCTL stress crack resistance of about 200 hours or greater, and (ii) a high density polyethylene resin selected from the group consisting of a homopolymer, high density polyethylene resin; a copolymer, high density polyethylene resin; and mixtures thereof. The composition is disclosed as having a minimum NCTL stress crack resistance of 24 hours. In another embodiment, a polyethylene composition comprises a melt blend of the bimodal, high molecular weight, high density polyethylene resin and a linear low density polyethylene resin. The composition is disclosed as useful for manufacture of profile, corrugated pipe and/or pipe fitting applications, and chemical waste applications, including sanitary sewer or irrigation piping systems.

International Publication No. WO 04/016688 discloses a polyethylene composition that has a density of about 0.945 to about 0.960 g/cc, and a melt flow index of about 0.1 to about 0.4. The composition is a melt blend of a linear low density polyethylene resin and/or a linear medium low density polyethylene resin, and a high density polyethylene resin. The resins can be virgin, recycled, scrap and/or wide specification resins, and mixtures of these.

International Publication No. WO 94/028064 discloses polyethylene compositions disclosed as having varying degrees of crystalline-amorphous regions. The compositions are obtained by combining high molecular weight, homopolymer polyethylene chains (M_{w} greater than, or equal to, about 1.5×10⁶) with conventional polyethylene polymers, such as low density, linear low density, and high density polyethylenes. The compositions are disclosed as having non-linear elongational characteristics, due to enhanced elasticity, and are suitable for film blowing and associated applications.

Additional compositions and/or articles are disclosed in International Publication No. WO 97/43323, International Publication No. WO 03/020821, European Application No. EP1674504A1, European Application No. 1669372A1, European Application No. 1669373A1, European Application No. 1676883A2, U.S. Pat. No. 6,800,692, U.S. Pat. No. 6,932,592, U.S. Pat. No. 6,841,621, U.S. Pat. No. 7,125,933, and U.S. Pat. No. 7,129,296

There is a need for polyethylene compositions that can be used in film and geomembrane fabrication processes, and which can be used to form articles with the appropriate thickness. There is a further need to produce such articles that have high stress crack resistance, high impact toughness and good tensile properties. Some of these needs and others have been met by the following invention.

### SUMMARY OF THE INVENTION

The invention provides a composition comprising at least one high molecular weight ethylene-based interpolymer, and at least one low molecular weight ethylene-based interpolymer, and

wherein the high molecular weight ethylene-based interpolymer has a density less than, or equal to, 0.960 g/cc, and a melt index (I5) less than, or equal to, 1.0 g/10 min; and

wherein the low molecular weight ethylene-based interpolymer has a density less than, or equal to, 0.915 g/cc, and a melt index (I2) greater than, or equal to, 0.4 g/10 min.

The invention also provides for articles prepared from the inventive compositions, and for methods of making the inventive compositions and the inventive articles.

### DETAILED DESCRIPTION OF THE INVENTION

As discussed above, the invention provides a composition comprising at least one high molecular weight ethylene-based interpolymer and at least one low molecular weight ethylene-based interpolymer, and

wherein the high molecular weight ethylene-based interpolymer has a density less than, or equal to, 0.960 g/cc, preferably less than, or equal to, 0.955 g/cc, and more preferably less than, or equal to, 0.952 g/cc; and a melt index (I5) less than, or equal to, 1.0 g/10 min, preferably less than, or equal to, 0.8 g/10 min, and more preferably less than, or equal to, 0.6 g/10 min; and

wherein the low molecular weight ethylene-based interpolymer has a density less than, or equal to, 0.915 g/cc, preferably less than, or equal to, 0.910 g/cc, more preferably less than, or equal to, 0.905 g/cc; and a melt index (I2) greater than, or equal to, 0.4 g/10 min, preferably greater than, or equal to, 0.6 g/10 min, and more preferably greater than, or equal to, 0.8 g/10 min.

In a further embodiment, the composition has a density less than, or equal to, 0.955 g/cc, preferably less than, or equal to, 0.952 g/cc, and more preferably less than, or equal to, 0.951 g/cc. In another embodiment, the composition has a melt index (I5) less than, or equal to, 1.0 g/10 min, preferably less than, or equal to, 0.8 g/10 min, and more preferably less than, or equal to, 0.6 g/10 min.

In another embodiment, the low molecular weight ethylene-based interpolymer has a density from 0.880 g/cc to 0.910 g/cc, and preferably from 0.890 g/cc to 0.905 g/cc.

In another embodiment, the high molecular weight ethylene-based interpolymer is a heterogeneously branched ethylene-based interpolymer, and preferably a heterogeneously branched ethylene/α-olefin interpolymer.

In another embodiment, the low molecular weight ethylene-based interpolymer is a heterogeneously branched ethylene-based interpolymer, and preferably a heterogeneously branched ethylene/α-olefin interpolymer.

In another embodiment, the high molecular weight ethylene-based interpolymer and the low molecular ethylene-based interpolymer are each, independently, a heterogeneously branched ethylene-based interpolymer, and preferably are each, independently, a heterogeneously branched ethylene/α-olefin interpolymer.

In another embodiment, the high molecular weight ethylene-based interpolymer is present in an amount greater than, or equal to, 60 weight percent, preferably greater than, or equal to, 62 weight percent, more preferably greater than, or equal to, 65 weight percent, based on the total weight of the composition.

In another embodiment, the low molecular weight ethylene-based interpolymer is present in an amount less than, or equal to, 35 weight percent, preferably less than, or equal to, 30 weight percent, more preferably less than, or equal to, 25 weight percent, based on the total weight of the composition.

In another embodiment, the high molecular weight ethylene-based interpolymer is an ethylene/α-olefin interpolymer. In a further embodiment, the α-olefin is selected from the group consisting of C3 to C10 α-olefins. In yet a further embodiment, the α-olefin is selected from the group consisting propylene, 1-butene, 1-pentene, 1-hexene, 1-heptene, 1-octene, 1-nonene and 1-decene, and preferably is selected from the group consisting propylene, 1-butene, 1-hexene and 1-octene.

In another embodiment, the low molecular weight ethylene-based interpolymer is an ethylene/α-olefin interpolymer. In a further embodiment, the α-olefin is selected from the group consisting of C3 to C10 α-olefins. In yet a further embodiment, the α-olefin is selected from the group consisting propylene, 1-butene, 1-pentene, 1-hexene, 1-heptene, 1-octene, 1-nonene and 1-decene, and preferably the α-olefin is selected from the group consisting propylene, 1-butene, 1-hexene and 1-octene.

In another embodiment, the composition further comprises one or more additional polymers. In another embodiment, the composition further comprises one or more additives. In a further embodiment, the one or more additives are selected from the group consisting of hindered amines, hindered phenols, metal deactivators, UV absorbers, phosphites, acid neutralizers, processing aids, fillers and combinations thereof.

In another embodiment, the composition further comprises a homogeneously branched linear ethylene/α-olefin interpolymer or a homogeneously branched substantially linear ethylene/α-olefin interpolymer. In a further embodiment, the α-olefin is selected from the group consisting of C3 to C10 α-olefins. In yet another embodiment, the α-olefin is selected from the group consisting propylene, 1-butene, 1-pentene, 1-hexene, 1-heptene, 1-octene, 1-nonene and 1-decene, and preferably, the α-olefin is selected from the group consisting propylene, 1-butene, 1-hexene and 1-octene.

In another embodiment, the homogeneously branched linear ethylene/α-olefin interpolymer has a density from 0.910 g/cc to 0.950 g/cc. In yet another embodiment, the homogeneously branched linear ethylene/α-olefin interpolymer has a melt index (I2) from 0.4 g/10 min to 4 g/10 min.

In another embodiment, the homogeneously branched substantially linear ethylene/α-olefin interpolymer has a density from 0.910 g/cc to 0.950 g/cc. In yet another embodiment, the homogeneously branched substantially linear ethylene/α-olefin interpolymer has a melt index (I2) from 0.4 g/10 min to 4 g/10 min.

In another embodiment, the homogeneously branched linear ethylene/α-olefin interpolymer is present in an amount less than, or equal to 5 weight percent, preferably less than, or equal to 4 weight percent, and more preferably less than, or equal to 3 weight percent, based on the total weight of the composition.

In another embodiment, the homogeneously branched substantially linear ethylene/α-olefin interpolymer is present in an amount less than, or equal to 5 weight percent, preferably less than, or equal to 4 weight percent, and more preferably less than, or equal to 3 weight percent, based on the total weight of the composition.

An inventive composition may comprise a combination of two or more embodiments as described herein.

The invention also provides an article comprising at least one component formed from an inventive composition. In one embodiment, the article is a film. In another embodiment, the article is a geomembrane, a drip tape or an agricultural tape.

In another embodiment, the article is a metal coating, and preferably a coating for steel. In another embodiment, the article is a pipe coating. In a further embodiment, the article is a coating for steel pipe. In yet another embodiment, the article is a blow molded article. In another embodiment, the article is a coated metal. In another embodiment, the article is a coated pipe.

An inventive article may comprise a combination of two or more suitable embodiments as described herein.

The invention also provides a method of preparing an inventive composition, said method comprising blending the at least one high molecular weight ethylene-based interpolymer and the at least one low molecular weight ethylene-based interpolymer. In a further embodiment, the blending is performed by a melt processing technique. In yet a further embodiment, the blending takes place in an extruder.

An inventive method may comprise a combination of two or more suitable embodiments as described herein.

### The High Molecular Weight (HMW) Component

In one embodiment, the high molecular weight ethylene-based interpolymer has a density greater than, or equal to, 0.945 g/cc, preferably greater than, or equal to, 0.948 g/cc, and more preferably greater than, or equal to, 0.950 g/cc (1 cc=1 cm³). In another embodiment, the high molecular weight ethylene-based interpolymer has a density less than, or equal to, 0.960 g/cc, preferably less than, or equal to, 0.955 g/cc, and more preferably less than, or equal to, 0.952 g/cc. In another embodiment, the density of the high molecular weight ethylene-based interpolymer is in the range from 0.945 to 0.960 g/cc, preferably in the range from 0.948 to 0.955 g/cc, and more preferably in the range from 0.950 to 0.952 g/cc.

In another embodiment, high molecular weight ethylene-based interpolymer has a melt index, I5 (190° C., 5.0 kg weight, ASTM 1238-04), greater than, or equal to, 0.2, preferably greater than, or equal to, 0.3, and more preferably greater than, or equal to, 0.4 (units of grams per 10 minutes). In another embodiment, the high molecular weight ethylene-based interpolymer has a melt index, I5, less than, or equal to, 1.0, preferably less than, or equal to, 0.8, and more preferably less than, or equal to, 0.6 (units of grams per 10 minutes). In another embodiment, the melt index (I5) is from 0.2 to 1.0 grams per 10 minutes, preferably from 0.3 to 0.8 grams per 10 minutes, more preferably from 0.4 to 0.6 grams per 10 minutes.

In another embodiment, the high molecular weight ethylene-based interpolymer is an ethylene/α-olefin interpolymer. In a preferred embodiment, the α-olefin is a C3-C20 α-olefin, a C4-C20 α-olefin, and more preferably a C4-C12 α-olefin, and even more preferably a C4-C8 α-olefin. In a further embodiment, the α-olefin is selected from propylene, 1-butene, 1-hexene and 1-octene, preferably 1-butene and 1-octene, and more preferably 1-butene.

The term “interpolymer,” as used herein, refers to a polymer having polymerized therein at least two monomers. It includes, for example, copolymers, terpolymers and tetrapolymers. As discussed above, it particularly includes a polymer prepared by polymerizing ethylene with at least one comonomer, typically an alpha olefin (α-olefin) of 3 to 20 carbon atoms (C3-C20), preferably 4 to 10 carbon atoms (C3-C10). Preferred α-olefins include propylene, 1-butene, 1-pentene, 1-hexene, 4-methyl-1-pentene, 1-heptene, and 1-octene. Especially preferred α-olefins include propylene, 1-butene, 1-hexene and 1-octene, and more preferably 1-butene.

Interpolymers include ethylene/butene (EB) copolymers, ethylene/hexene-1 (EH), ethylene/octene-1 (EO) copolymers, ethylene/alpha-olefin/diene modified (EAODM) interpolymers such as ethylene/propylene/diene modified (EPDM) interpolymers, and ethylene/propylene/octene terpolymers. Preferred copolymers include EB, EH and EO copolymers, more preferably EB and EO copolymers, and most preferably EB copolymers.

In a preferred embodiment, the high molecular weight component is an ethylene/α-olefin interpolymer, which is produced by a slurry, a solution or a gas phase process using one or more Ziegler/Natta catalysts, or one or more metallocene catalysts, and more preferably using one or more Ziegler/Natta catalysts.

In a preferred embodiment, the high molecular weight ethylene-based interpolymer is a multimodal component, and preferably a bimodal component.

The high molecular weight component may comprise a combination of two or more embodiments as described herein.

### The Low Molecular Weight (LMW) Component

In one embodiment, the low molecular weight ethylene-based interpolymer has a density greater than, or equal to, 0.880 g/cc, preferably greater than, or equal to, 0.885 g/cc, and more preferably greater than, or equal to, 0.890 g/cc. In another embodiment, the low molecular weight ethylene-based interpolymer has a density less than, or equal to, 0.915 g/cc, preferably less than, or equal to, 0.910 g/cc, and more preferably less than, or equal to, 0.905 g/cc. In another embodiment, the density ranges from 0.880 to 0.915 g/cc, preferably from 0.885 to 0.910 g/cc, and more preferably from 0.890 to 0.905 g/cc. In another embodiment, the low molecular weight ethylene-based interpolymer has a density less than 0.910 g/cc, preferably less than, or equal to, 0.905 g/cc.

In another embodiment, low molecular weight ethylene-based interpolymer has a melt index, I2 (190° C., 2.16 kg weight, ASTM 1238-04), greater than, or equal to, 0.4, preferably greater than, or equal to, 0.6, and more preferably greater than, or equal to, 0.8 (units of grams per 10 minutes). In another embodiment, the low molecular weight ethylene-based interpolymer has a melt index, I2, less than, or equal to, 2, preferably less than, or equal to, 1.5, and more preferably less than, or equal to, 1 (units of grams per 10 minutes). In another embodiment, the melt index (I2) is from 0.4 to 2 grams per 10 minutes, preferably from 0.6 to 1.5 grams per 10 minutes, more preferably from 0.8 to 1 grams per 10 minutes.

In another embodiment, the low molecular weight ethylene-based interpolymer has a molecular weight distribution (M_{w}/Mₙ) greater than 3, preferably greater than, or equal to, 3.5, more preferably greater than, or equal to, 4, and even more preferably greater than, or equal to, 4.2. In another embodiment, the low molecular weight ethylene-based interpolymer has a weight distribution (M_{w}/Mₙ) less than, or equal to, 6, preferably less than, or equal to, 5.5, more preferably less than, or equal to, 5.

In another embodiment, the low molecular weight ethylene-based interpolymer is an ethylene/α-olefin interpolymer. In a preferred embodiment, the α-olefin is a C3-C20 α-olefin, a preferably a C3-C10 α-olefin. Preferred α-olefins include propylene, 1-butene, 1-pentene, 1-hexene, 4-methyl-1-pentene, 1-heptene, and 1-octene. Especially preferred α-olefins include propylene, 1-butene, 1-hexene and 1-octene, more preferably 1-butene and 1-octene, and most preferably 1-octene.

Interpolymers include ethylene/butene-1 (EB) copolymers, ethylene/hexene-1 (EH), ethylene/octene-1 (EO) copolymers, ethylene/alpha-olefin/diene modified (EAODM) interpolymers such as ethylene/propylene/diene modified (EPDM) interpolymers, and ethylene/propylene/octene terpolymers. Preferred copolymers include EB, EH and EO copolymers, more preferred EB and EO copolymers, and most preferred EO copolymers.

In a preferred embodiment, the low molecular weight component is an ethylene/α-olefin interpolymer, which can be produced by a slurry, a solution or a gas phase process, preferably using one or more Ziegler/Natta catalysts, or one or more metallocene catalysts, and more preferably using one or more Ziegler/Natta catalysts.

The low molecular weight component may comprise a combination of two or more embodiments as described herein.

### Ethylene-Based Interpolymers

The high molecular weight ethylene-based interpolymer and the low molecular weight ethylene-based interpolymer, each as discussed above, may be each, independently, a heterogeneously branched linear ethylene-based interpolymer, a homogeneously branched linear ethylene-based interpolymer, or a homogeneously branched substantially linear ethylene-based interpolymer.

Heterogeneously branched linear ethylene-based interpolymers differ from the homogeneously branched ethylene-based interpolymers, primarily in their comonomer branching distribution. For example, heterogeneously branched interpolymers have a branching distribution, in which the polymer molecules do not have the same ethylene-to-comonomer ratio. Heterogeneously branched ethylene-based interpolymers are typically prepared with a Ziegler/Natta catalyst system. These linear interpolymers lack long chain branching (or measurable amounts of long chain branching).

Heterogeneously branched ethylene-based interpolymers include, but are not limited to, linear medium density polyethylene (LMDPE), linear low density polyethylene (LLDPE), very low density polyethylene (VLDPE), and ultra low density polyethylene (ULDPE). Commercial polymers include DOWLEX™ polymers, ATTANE™ polymer and FLEXOMER™ polymers (all from The DOW Chemical Company), and ESCORENE™ AND EXCEED™ polymers (both from ExxonMobil Chemical Company).

In preferred embodiment, both the high molecular weight ethylene-based interpolymer and the low molecular weight ethylene-based interpolymer are each, independently, prepared using one or more Ziegler/Natta catalysts.

The terms “homogeneous” and “homogeneously-branched” are used typically in reference to an ethylene/α-olefin interpolymer, in which the comonomer is randomly distributed within a given polymer molecule, and substantially all of the polymer molecules have the same ethylene-to-comonomer ratio. These interpolymers are typically prepared using a single site catalyst system (for example, a metallocene catalyst system or a constrained geometry catalyst system).

The homogeneously branched linear ethylene interpolymers are ethylene interpolymers, which lack long chain branching (or measurable amounts of long chain branching), but do have short chain branches, derived from the comonomer polymerized into the interpolymer, and in which the comonomer is homogeneously distributed, both within the same polymer chain, and between different polymer chains. Homogeneously branched linear ethylene interpolymers lack long chain branching, just as is the case for the linear low density polyethylene polymers or linear high density polyethylene polymers.

Commercial examples of homogeneously branched linear ethylene/α-olefin interpolymers include TAFMER™ polymers supplied by the Mitsui Chemical Company, and EXACT™ polymers supplied by ExxonMobil Chemical Company.

The homogeneously branched substantially linear ethylene interpolymers are described in U.S. Pat. Nos. 5,272,236; 5,278,272; 6,054,544; 6,335,410 and 6,723,810; each fully incorporated herein by reference. The substantially linear ethylene interpolymers are those in which the comonomer is randomly distributed within a given interpolymer molecule, and in which substantially all of the interpolymer molecules have the same ethylene/comonomer ratio within that interpolymer. In addition, the substantially linear ethylene interpolymers are homogeneously branched ethylene interpolymers having long chain branching. The long chain branches have substantially the same comonomer distribution as the polymer backbone, and can have about the same length as the length of the polymer backbone. “Substantially linear,” typically, is in reference to a polymer that is substituted, on average, with 0.01 long chain branches per 1000 total carbons. The length of a long chain branch is longer than the carbon length of a short chain branch formed from the incorporation of one comonomer into the polymer backbone.

Some polymers may be substituted with 0.01 long chain branches per 1000 total carbons to 1 long chain branch per 1000 total carbons, or from 0.05 long chain branches per 1000 total carbons to 1 long chain branch per 1000 total carbons, or from 0.3 long chain branches per 1000 total carbons to 1 long chain branch per 1000 total carbons. Commercial examples of substantially linear polymers include the ENGAGE™ polymers and AFFINITY™ polymers (both available from The Dow Chemical Company).

The substantially linear ethylene interpolymers form a unique class of homogeneously branched ethylene polymers. They differ substantially from the well-known class of conventional, homogeneously branched linear ethylene interpolymers, described by Elston in U.S. Pat. No. 3,645,992, and, moreover, they are not in the same class as conventional heterogeneous “Ziegler-Natta catalyst polymerized” linear ethylene polymers (for example, ultra low density polyethylene (ULDPE), linear low density polyethylene (LLDPE) or high density polyethylene (HDPE) made, for example, using the technique disclosed by Anderson et al., in U.S. Pat. No. 4,076,698); nor are they in the same class as high pressure, free-radical initiated, highly branched polyethylenes, such as, for example, low density polyethylene (LDPE), ethylene-acrylic acid (EAA) copolymers and ethylene vinyl acetate (EVA) copolymers.

The homogeneously branched, substantially linear ethylene interpolymers have excellent processability, even though they have a relatively narrow molecular weight distribution. Surprisingly, the melt flow ratio (I10/I2), according to ASTM D 1238, of the substantially linear ethylene interpolymers can be varied widely, and essentially independently of the molecular weight distribution (M_{w}/Mₙ or MWD). This surprising behavior is completely contrary to conventional homogeneously branched linear ethylene interpolymers, such as those described, for example, by Elston in U.S. Pat. No. 3,645,992, and heterogeneously branched conventional Ziegler-Natta polymerized linear polyethylene interpolymers, such as those described, for example, by Anderson et al., in U.S. Pat. No. 4,076,698. Unlike substantially linear ethylene interpolymers, linear ethylene interpolymers (whether homogeneously or heterogeneously branched) have rheological properties, such that, as the molecular weight distribution increases, the I10/I2 value also increases.

“Long chain branching (LCB)” can be determined by conventional techniques known in the industry, such as 13C nuclear magnetic resonance (13C NMR) spectroscopy, using, for example, the method of Randall (Rev. Micromole. Chem. Phys., C29 (2&3), 1989, p. 285-297). Two other methods are gel permeation chromatography, coupled with a low angle laser light scattering detector (GPC-LALLS), and gel permeation chromatography, coupled with a differential viscometer detector (GPC-DV). The use of these techniques for long chain branch detection, and the underlying theories, have been well documented in the literature. See, for example, Zimm, B. H. and Stockmayer, W. H., J. Chem. Phys., 17,1301(1949) and Rudin, A., Modern Methods of Polymer Characterization, John Wiley & Sons, New York (1991) pp. 103-112.

The homogeneous branched ethylene polymers will preferably have a single melting peak, as measured using differential scanning calorimetry (DSC), in contrast to heterogeneously branched linear ethylene polymers, which typically have two or more melting peaks, due to the heterogeneously branched polymer's broad branching distribution.

### Polyethylene Composition

In a preferred embodiment, the composition has a density greater than, or equal to, 0.930 g/cc, preferably greater than, or equal to, 0.935 g/cc, and more preferably greater than, or equal to, 0.940 g/cc. In another embodiment, composition has a density less than, or equal to, 0.955 g/cc, preferably less than, or equal to, 0.952 g/cc, more preferably less than, or equal to, 0.951 g/cc. In another embodiment, the composition has a density from 0.930 to 0.955 g/cc, and preferably from 0.935 to 0.952 g/cc, and more preferably from 0.940 to 0.951 g/cc. In another embodiment, the composition has a density from 0.945 g/cc to 0.955 g/cc, and preferably from 0.950 g/cc to 0.955 g/cc.

In another embodiment, the composition has a melt index, I5 (190° C., 5.0 kg weight, ASTM 1238-04) greater than, or equal to, 0.2 g/10 min, preferably greater than, or equal to, 0.3 g/10 min, and more preferably greater than, or equal to, 0.4 g/10 min. In another embodiment, composition has a melt index (I5) less than, or equal to, 1.0 g/10 min, preferably less than, or equal to, 0.8 g/10 min, and more preferably less than, or equal to, 0.6 g/10 min. In another embodiment, the composition has a melt index (I5) from 0.2 to 1.0 g/10 min, preferably from 0.3 to 0.8 g/10 min, and more preferably from 0.4 to 0.6 g/10 min.

In another embodiment, the composition has a melt index, I2 (190° C., 2.16 kg weight, ASTM 1238-04), from 0.05 to 0.5 g/10 min, preferably from 0.1 to 0.4 g/10 min, and more preferably from 0.1 to 0.3 g/10 min.

In another embodiment, the composition has a molecular weight distribution (M_{w}/Mₙ) greater than, or equal to, 15, preferably greater than, or equal to, 17. In another embodiment, the composition has a molecular weight distribution (M_{w}/Mₙ) less than, or equal to, 30, preferably less than, or equal to, 25.

In one embodiment, the high molecular weight ethylene-based interpolymer is present in an amount less than, or equal to, 85 weight percent, preferably less than, or equal to, 80 weight percent, and more preferably less than, or equal to, 75 weight percent, based on the total weight of the composition. In one embodiment, the high molecular weight ethylene-based interpolymer is present in an amount greater than, or equal to, 60 weight percent, preferably greater than, or equal to, 62 weight percent, and more preferably greater than, or equal to 65 weight percent, based on the total weight of the composition.

In another embodiment, the low molecular weight ethylene-based interpolymer is present in an amount greater than, or equal to, 15 weight percent, preferably greater than, or equal to, 20 weight percent, and more preferably greater than, or equal to, 25 weight percent, based on the total weight of the composition. In another embodiment, the low molecular weight ethylene-based interpolymer is present in an amount less than, or equal to, 35 weight percent, preferably less than, or equal to, 30 weight percent, and more preferably less than, or equal to, 25 weight percent, based on the total weight of the composition.

In another embodiment, the low molecular weight ethylene-based interpolymer is present in an amount from 20 to 30 weight percent, preferably from 20 to 28 weight percent, based on the sum weight of the low molecular weight component and the high molecular weight component. In another embodiment, the high molecular weight ethylene-based interpolymer is present in an amount from 70 to 80 weight percent, preferably from 72 to 80 weight percent, based on the sum weight of the low molecular weight component and the high molecular weight component.

In another embodiment, the weight ratio of the high molecular weight ethylene-based interpolymer to the low molecular weight ethylene-based interpolymer is from 2.4 to 3.2, preferably from 2.6 to 3.1.

In another embodiment, the composition further comprises a homogeneously branched linear ethylene/α-olefin interpolymer or a homogeneously branched substantially linear ethylene/α-olefin interpolymer, and preferably comprises a homogeneously branched substantially linear ethylene/α-olefin interpolymer. In a further embodiment, the α-olefin is selected from the group consisting of C3 to C10 α-olefins. In yet another embodiment, the α-olefin is selected from the group consisting propylene, 1-butene, 1-pentene, 1-hexene, 1-heptene, 1-octene, 1-nonene and 1-decene, and preferably, the α-olefin is selected from the group consisting propylene, 1-butene, 1-hexene and 1-octene.

In another embodiment, the homogeneously branched substantially linear ethylene/α-olefin interpolymer has a melt index (I2) from 0.4 to 4 g/10 min, preferably from 0.5 to 3.5 g/10 min, and more preferably from 0.6 to 3 g/10 min.

In another embodiment, the homogeneously branched substantially linear ethylene/α-olefin interpolymer has a density from 0.910 to 0.950 g/cc, preferably from 0.920 to 0.940 g/cc, and more preferably from 0.925 to 0.935 g/cc.

In another embodiment, the homogeneously branched substantially linear ethylene/α-olefin interpolymer has a density from 0.855 to 0.930 g/cc, preferably from 0.860 to 0.925 g/cc, and more preferably from 0.865 to 0.920 g/cc.

In another embodiment, the homogeneously branched linear ethylene/α-olefin interpolymer has a melt index (I2) from 0.4 to 4 g/10 min, preferably from 0.5 to 3.5 g/10 min, and more preferably from 0.6 to 3 g/10 min.

In another embodiment, the homogeneously branched linear ethylene/α-olefin interpolymer has a density from 0.910 to 0.950 g/cc, preferably from 0.920 to 0.940 g/cc, and more preferably from 0.925 to 0.935 g/cc.

In another embodiment, the homogeneously branched linear ethylene/α-olefin interpolymer has a density from 0.855 to 0.930 g/cc, preferably from 0.860 to 0.925 g/cc, and more preferably from 0.865 to 0.920 g/cc.

The composition may comprise a combination of two or more embodiments as described herein.

The novel composition can be made by a variety of methods. For example, it may be made by blending or mixing, preferably in the melt, the high molecular weight ethylene-based interpolymer and the low molecular weight ethylene-based interpolymer, or by melt-blending the individually melted components. Alternatively, it may be made in situ, in one or more polymerization reactors, including, but not limited to, a dual reactor configuration.

Optional polymers and/or additives may be added to an inventive composition in a dry blending process, a melt blending process, or any suitable process known in the art.

### Additives

The inventive compositions may contain one or more additional components or additives. Suitable additional components include, for example, other polymers, fillers or additives, with the proviso that these additional components do not adversely interfere with the desired advantageous properties of the compositions of the invention. Rather, the additional components are selected, such as to support the advantageous properties of an inventive composition, and/or to support or enhance the composition's particular suitability for a desired application. “Other polymers” comprised in the composition of the invention, mean polymers which do not qualify as the high molecular weight ethylene-based interpolymer, as discussed herein, or a low molecular weight ethylene-based interpolymer, as discussed herein. Advantageously, such polymers are compatible with the inventive composition. In one embodiment, the additional polymer is used as a carrier resin for one or more additives, such as a colorant.

Additives include, but are not limited to, processing aids, acid neutralizers, UV stabilizers, antioxidants, process stabilizers, metal de-activators, additives to improve oxidative resistance, pigments, colorants or fillers.

Effective additive packages are needed to protect the excellent mechanical properties during the life time of the fabricated parts, where the parts are exposed to UV environment. For applications where chlorine resistance is needed, a synergetic antioxidant system comprising two or more hindered phenols is used. The first class of hindered phenols comprises the hindered phenols that exhibit excellent antioxidant reactivity (oxidation by oxygen), and the second class of hindered phenol comprises the hindered phenols that have a good water extraction resistance.

Stabilizers to protect against degradation or consumption of additives during conversion from granular form to pellets, and in the extrusion of the resin, include phosphites, which act to prevent degradation of the phenolic type stabilizers, so they are not consumed prior to the long term usage of the end product.

In one embodiment, an inventive composition contains one or more additives selected from hindered amines, hindered phenols, metal deactivators, UV absorbers, phosphites, acid neutralizers, processing aids, fillers, and combinations thereof.

### Applications

The compositions of the invention can be used to manufacture a shaped article, or one or more components of a shaped article. Such articles may be single layered or multilayered, and are typically obtained by suitable known conversion techniques, such as applying heat, pressure, or a combination thereof, to obtain the desired article. Suitable conversion techniques include, for example, blown film, blow-molding, co-extrusion blow-molding, injection molding, injection stretch blow molding, compression molding, extrusion, coextrusion, pultrusion, calendering and thermoforming. Shaped articles include, but are not limited to, films, drip tapes and tubings, geomembranes, sheets, fibers, profiles, pipes, moldings, and metal coatings.

Film and film structures particularly benefit from this invention, and can be made using conventional blown film fabrication techniques, or other, preferably biaxial, orientation processes, such as tenter frames or double bubble processes. Conventional blown film processes are described, for example, in The Encyclopedia of Chemical Technology, Kirk-Othmer, Third Edition, John Wiley & Sons, New York, 1981, Vol. 16, pp. 416-417 and Vol. 18, pp. 191-192. Biaxial orientation film manufacturing process, such as described in a “double bubble” process, as in U.S. Pat. No. 3,456,044 (Pahlke), and the processes described in U.S. Pat. No. 4,352,849 (Mueller), U.S. Pat. No. 4,597,920 (Golike), U.S. Pat. No. 4,820,557 (Warren), U.S. Pat. No. 4,837,084 (Warren), U.S. Pat. No. 4,865,902 (Golike et al.), U.S. Pat. No. 4,927,708 (Herran et al.), U.S. Pat. No. 4,952,451 (Mueller), U.S. Pat. No. 4,963,419 (Lustig et al.), and U.S. Pat. No. 5,059,481 (Lustig et al.). The film structures can also be made in a tenter-frame technique, such as that used for oriented polypropylene.

Other multi-layer film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 31-80 (published by the TAPPI Press (1992)).

The films may be monolayer or multilayer films. The film made using this invention can also be coextruded with the other layer(s), or the film can be laminated onto another layer(s) in a secondary operation, such as that described in “Packaging Foods With Plastics,” by Wilmer A. Jenkins and James P. Harrington (1991), or that described in “Coextrusion For Barrier Packaging” by W. J. Schrenk and C. R. Finch, Society of Plastics Engineers RETEC Proceedings, Jun. 15-17 (1981), pp. 211-229. If a monolayer film is produced via tubular film (that is, blown film techniques, preferably on grooved barrel extruders) or flat die (that is, cast film), as described by K. R. Osborn and W. A. Jenkins in “Plastic Films, Technology and Packaging Applications” (Technomic Publishing Co., Inc., 1992), the disclosure of which is incorporated herein by reference, then the film typically goes through an additional post-extrusion step of adhesive or extrusion lamination to other packaging material layers to form a multilayer structure. If the film is a coextrusion of two or more layers (also described by Osborn and Jenkins), the film may still be laminated to additional layers of packaging materials, depending on the other physical requirements of the final film. “Laminations vs. Coextrusion” by D. Dumbleton (Converting Magazine (September 1992), also discusses lamination versus coextrusion. Monolayer and coextruded films can also go through other post extrusion techniques, such as “radiation induced cross-linking” of the polymer, and a biaxial orientation process.

Extrusion coating is yet another technique for producing multilayer film structures using the novel compositions described herein. The novel compositions comprise at least one layer of the film structure. Similar to cast film, extrusion coating is a flat die technique. A sealant can be extrusion coated onto a substrate, either in the form of a monolayer or a coextruded extrudate.

Generally for a multilayer film structure, the novel compositions described herein comprise at least one layer of the total multilayer film structure. Other layers of the multilayer structure include, but are not limited to, barrier layers, and/or tie layers, and/or structural layers. Various materials can be used for these layers, with some of them being used as more than one layer in the same film structure. Some of these materials include: foil, nylon, ethylene/vinyl alcohol (EVOH) copolymers, polyvinylidene chloride (PVDC), PET, oriented polypropylene (OPP), ethylene/vinyl acetate (EVA) copolymers, ethylene/acrylic acid (EAA) copolymers, ethylene/methacrylic acid (EMAA) copolymers, LLDPE (linear low density polyethylene), HDPE, LDPE (low density polyethylene), nylon, graft adhesive polymers (for example, maleic anhydride grafted polyethylene), and paper. Generally, the multilayer film structures comprise from two to seven layers.

The compositions of the invention can be used for the formation of geomembranes, which are essentially impermeable synthetic sheets used for the containment of liquids, gases and/or solids. Geomembranes are used to convey water, hold water, cover water, and/or protect water, by containing hazardous materials. Geomembranes are also used an hydraulic barrier in purification processes, and as a gas barrier. In particular, geomembranes are used to contain water for agricultural use, and/or to keep pollutants out of a clean water supply. A geomembrane may be prepared by sealing, via heat or other means, films or sheets formed from polyolefin compositions, along one or more overlapping seams, to create a long, wide sheet with fused overlaps. A geomembrane may also be formed from sheets of polymer that are welded together on the site of end use, such as on a piece a farm land. Films and sheets may contain multiple layers of coextruded polymer compositions. Polyolefins may be coextruded with polar polymers, such as polyamides, ethylene vinyl alcohol, and polyesters.

The compositions according to the present invention may also be used for durable applications, and may be used for blow-molding applications, and for the formation of automotive parts. Examples of such articles include a bottle, a drums, a fuel tank, a seat back, a head rest, a knee bolster, a glove box door, an instrument panel, a bumper facia, a bumper beam, a center console, an intake manifold, a spoiler, a side molding, a pillar, a door trim, an airbag cover, a HVAC duct, a spare tire cover, a fluid reservoir, a rear window shelf, a resonator, a trunk board, and an arm rest.

The inventive compositions are also suitable for use as a metal coating, including, but not limited to, a coating for steel. The inventive compositions may also be used as coatings for pipes, such as steel pipes.

### Definitions

Any numerical range recited herein, includes all values from the lower value and the upper value, in increments of one unit, provided that there is a separation of at least two units between any lower value and any higher value. As an example, if it is stated that a compositional, physical or other property, such as, for example, melt index, is from 100 to 1,000, it is intended that all individual values, such as 100, 101, 102, etc., and sub ranges, such as 100 to 144, 155 to 170, 197 to 200, etc., are expressly enumerated in this specification. For ranges containing values which are less than one, or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this application. Numerical ranges have been recited, as discussed herein, in reference to density, melt index, weight percent of component, and other properties.

The term “polymer” is used herein to indicate, a homopolymer, a copolymer, or a terpolymer, and the like. The term “polymer,” as used herein, includes interpolymers, such as those made by the copolymerization of ethylene with C3-C10 alpha olefins, or polypropylene with C4-C10 alpha olefins.

The term “interpolymer,” as used herein, refers to polymers prepared by the polymerization of at least two different types of monomers. The generic term interpolymer thus includes copolymers, usually employed to refer to polymers prepared from two different types of monomers, and polymers prepared from more than two different types of monomers.

The term “ethylene-based interpolymer,” as used herein, refers to an interpolymer that contains at least a majority mole percent ethylene (based on total moles of polymerizable monomers), and one or more additional comonomers.

The term “ethylene/α-olefin interpolymer,” as used herein, refers to an ethylene-based interpolymer that contains at least a majority mole percent ethylene (based on total moles of polymerizable monomers), an α-olefin, and optionally, one or more additional comonomers.

The terms “unimodal,” “unimodal component,” and similar terms, as used herein, in reference to the overall MWD (molecular weight distribution) of a comparative example, or in reference to the MWD of a component polymer of the inventive composition, refer to the MWD in a Gel Permeation Chromatography (GPC) curve, and in which the curve does not substantially exhibit multiple component polymers, that is, no humps, shoulders or tails exist, or are substantially discernible, in the GPC curve. In other words, the DOS (Degree of Separation) is zero or substantially close to zero.

The terms “bimodal,” “bimodal component,” and similar terms, as used herein, refer to the MWD in a GPC curve which exhibits two component polymers, and wherein one component polymer may even exist as a hump, shoulder or tail relative to the MWD of the other component polymer.

The terms “multimodal,” “multimodal component,” and similar terms, as used herein, refer to the MWD in a GPC curve, which exhibits more than two component polymers, and wherein one component polymer may even exist as a hump, shoulder or tail relative to the MWD of another component polymer.

The term “melt processing” is used to mean any process, in which the polymer is softened or melted, such as extrusion, pelletizing, film blowing, casting, thermoforming, compounding in polymer melt form, and the like.

The term “extruder” is used for its broadest meaning to include such devices, as a device which extrudes pellets or a pelletizer.

The terms “blend” or “polymer blend,” as used herein, mean a blend of two or more polymers. Such a blend may or may not be miscible. Such a blend may or may not be phase separated. Such a blend may or may not contain one or more domain configurations, as determined from transmission electron microscopy, light scattering, x-ray scattering, and other methods known in the art.

### Test Methods

### Density

Sample preparation: ASTM:D1928-96

Sample analyses: ASTM:D792-00/ISO ISO1183-04

Samples (HMW component and final composition) are prepared according ASTM D1928-96. Samples (pellets) were compression molded in defined steps, as specified in the standard, and cooled down according defined speeds, as specified in the standard [a) compression molding plate: size: 120 mm×120 mm×3.2 mm, or 75 mm×120 mm×3.2 mm; b) test specimen: part is stamped with ASTM Stamp according D1693, size ½″×1½″]. After the preparation, the samples were annealed in an oven at 100° C., and relaxed for 4 hours at about 50% humidity and about 23° C. The density measurement was done with a Toyoseiki Densiometer, what should be understood as an automated Archimedes method in accordance with ISO1183-04.

Samples (LMW component) are prepared according ASTM D4703-03, Annex A1, Procedure C. Samples (pellets) were compression molded in defined steps, as specified in the standard, and cooled down according defined speeds, as specified in the standard [a) polymer sample (approximately 20 grams) was compression molded; b) test specimen size: 3 mm×13 mm×38 mm]. After the preparation, the density was measured within one hour in accordance with ASTM D792-00.

### Melt Index by Extrusion Plastomer

Melt index measurements were performed according to ISO 1133-04, Condition 190° C./2.16 kg and Condition 190° C./5.0 kg, which are known as I2 and I5, respectively. Melt index is inversely proportional to the molecular weight of the polymer. Thus, the higher the molecular weight, the lower the melt index, although the relationship is not linear.

### High Temperature Gel Permeation Chromatography (GPC) Analytical Method

Polymer samples may be analyzed by conventional gel permeation chromatography (GPC) on a “Waters GPCV2000 series high temperature unit,” equipped with refractometer detector, IR4 detector at concentration mode (Polymerchar, Spain), light scattering (MALS) and online viscometer. For conventional GPC, only the IR4 is used. Four PLgel Mixed A (20 μm) columns with a guard column are used. The oven temperature is at 145° C., with the autosampler hot, and the warm zone at 145° C. The solvent is distilled and filtered over silica. The solvent is 1,2,4-trichlorobenzene (TCB) containing 200 ppm of 2,6-di-t-butyl-4-methylphenol (BHT). The flow rate is 1.0 ml/min, and the injection size is 200 μl. A “3 mg/ml sample concentration” is prepared by dissolving the sample in distilled TCB, containing 200 ppm BHT, for 2 to 4 hours, at 165° C., with gentle agitation.

The molecular weight determination is deduced by using 10 narrow molecular weight distribution polystyrene standards, ranging from Mp 580-7,500,000 (Polymer Laboratories). The equivalent polyethylene molecular weights are calculated by using appropriate Mark-Houwink constants and q-value (0.3837). Molecular weight distributions are determined from the average molecular weights as known in the art.

### EXPERIMENTAL

The following examples are to illustrate this invention and to not limit it.

Ratios, parts, and percentages are by weight, and based on the total weight of the composition, unless otherwise stated. The following compositions were prepared by melt blending the noted components. One or more stabilizers may be added to each composition, and/or to one or more polymer components of the composition.

### Composition I

| | | |
|---|---|---|
| 68.94 | wt % | High molecular weight ethylene-based interpolymer, |
| | | bimodal slurry powder (I5 of 0.46, density of 0.9515 |
| | | (annealed) g/cc, comonomer = 1-butene) |
| 25 | wt % | Low molecular weight ethylene-based interpolymer (I2 |
| | | of 0.8, density of 0.905 g/cc, MI10/MI2 of 8.1, |
| | | comonomer = 1-octene). |
| 5.62 | wt % | Carbon black masterbatch, based on an 59.85 wt % |
| | | ethylene/1-octene copolymer (I2 of 0.7, density of |
| | | 0.933 g/cc (density measured in accordance with the |
| | | procedure specified for LMW component), and 40 wt % |
| | | carbon black |

Composition I has a melt index (I5) of 0.51 g/10 min, and a density of 0.9505 (annealed) g/cc.

Composition I has the following properties (Ultimate Tensile Strength, Ultimate Elongation and Tensile Yield), which were based on compression molded specimens prepared according to DIN EN ISO 1882-2:
Producing plates according DIN EN ISO 1882-2
Equipment: Plate press Collin I, 400*400 Type 6401
Temperature: 180° C.
Preheating time: 5 min
Hold pressure time 5 min
Cooling rate: 15 K/min
Low Pressure: 5 bar (0.1 N/mm²)
High Pressure: 200 bar (10 N/mm²)
Mold: 165×165×4 mm
   The samples were produced by sawing and milling of the plates, the shape of the samples is according ISO 527-3,
Specimen: Type 1B (Tensile),
Equipment: Precision-saw Diadisc 5200 (Fa. Mutronic) Fräsboy (Fa. Göttfert)
Tool: Test specimen Type 1B according to ISO 527
Conditioning: specimens are conditioned more than 24 hours at 23° C./50% rel.Hum.
Tensile test ISO 527-1.2
Specimen type: Type 1B
Test conditions: 23° C.
Number of test specimen: 5 per test
Tensile tester: ZWICK 1446
Chamber: T.S.048
Load cell: 10 kN
Grips: wedge stressed grips, 8301
Extensiometer: Makro, 625 mm,
Gage length: 50 mm
Grips distance: 115 mm
Test speed E-Modulus: 1 mm/min
Test speed: 50 mm/min
Ultimate Tensile Strength (ISO 527 at 23° C.) from 29 MPa to 35 MPa;
Ultimate Elongation (ISO 527 at 23° C.) from 500% to 800%;
Tensile Yield (ISO 527 at 23° C.) from 16 MPa to 20 MPa.

### Composition II

| | | |
|---|---|---|
| 74.6 | wt % | High molecular weight ethylene-based interpolymer, |
| | | bimodal slurry powder (I5 of 0.46, density of 0.9515 |
| | | (annealed) g/cc, comonomer = 1-butene) |
| 25 | wt % | Low molecular weight ethylene-based interpolymer (I2 |
| | | of 0.8, density of 0.905 g/cc, MI10/MI2 of 8.1, |
| | | comonomer = 1-octene). |

Composition II has a melt index, I5, of 0.55 g/10 min, and a density of 0.9405 (annealed) g/cc.

Composition II should have the following properties (compression molded sample, and sample preparation as discussed above for Composition I): Ultimate Tensile Strength (ISO 527 at 23 C) from 25 MPa to 30 MPa; Ultimate Elongation (ISO 527 at 23 C) from 500% to 750%; Tensile Yield (ISO 527 at 23 C) from 15 MPa to 18 MPa.

The compositions have good tensile and elongation properties, and good melt strength as demonstrated from blown film processes known in the art. Both compositions can each be formed into blown films and geomembranes by those skilled in the art, using film processing techniques known in the art.

1. A composition comprising at least one high molecular weight ethylene-based interpolymer, and at least one low molecular weight ethylene-based interpolymer, and
wherein the high molecular weight ethylene-based interpolymer has a density less than, or equal to, 0.960 g/cc, and a melt index (I5) less than, or equal to, 1.0 g/10 min; and
wherein the low molecular weight ethylene-based interpolymer has a density less than, or equal to, 0.915 g/cc, and a melt index (I2) greater than, or equal to, 0.4 g/10 min.

2. The composition of claim 1, wherein the composition has a density less than, or equal to, 0.955 g/cc.

3. The composition of claim 1, wherein the low molecular weight ethylene-based interpolymer has a density from 0.880 g/cc to 0.910 g/cc.

4. The composition of claim 1, wherein the composition has a melt index (I5) less than, or equal to, 1.0 g/10 min.

5. The composition of claim 1, wherein high molecular weight ethylene-based interpolymer is a heterogeneously branched ethylene-based interpolymer.

6. The composition of claim 1, wherein high molecular weight ethylene-based interpolymer and the low molecular ethylene-based interpolymer are each, independently, a heterogeneously branched ethylene-based interpolymer.

7. The composition of claim 1, wherein the high molecular weight ethylene-based interpolymer is present in an amount greater than, or equal to, 60 weight percent, based on the total weight of the composition.

8. The composition of claim 1, wherein the low molecular weight ethylene-based interpolymer is present in an amount less than, or equal to, 35 weight percent, based on the total weight of the composition.

9. The composition of claim 1, wherein the high molecular weight ethylene-based interpolymer is an ethylene/α-olefin interpolymer.

10-12. (canceled)

13. The composition of claim 1, wherein the low molecular weight ethylene-based interpolymer is an ethylene/α-olefin interpolymer.

14-19. (canceled)

20. The composition of claim 1, wherein the composition further comprises a homogeneously branched linear ethylene/α-olefin interpolymer or a homogeneously branched substantially linear ethylene/α-olefin interpolymer.

21. The composition of claim 20, wherein the composition further comprises a homogeneously branched substantially linear ethylene/α-olefin interpolymer.

22. The composition of claim 20, wherein the homogeneously branched linear ethylene/α-olefin interpolymer or the homogeneously branched substantially linear ethylene/α-olefin interpolymer has a density from 0.910 g/cc to 0.950 g/cc.

23. The composition of claim 20, wherein the homogeneously branched linear ethylene/α-olefin interpolymer or the homogeneously branched substantially linear ethylene/α-olefin interpolymer has a melt index (I2) from 0.4 g/10 min to 4 g/10 min.

24-27. (canceled)

28. An article comprising at least one component formed from the composition of claim 1.

29. The article of claim 28, wherein the article is a film.

30-34. (canceled)

35. A method of preparing the composition of claim 1, said method comprising blending the at least one high molecular weight ethylene-based interpolymer and the at least one low molecular weight ethylene-based interpolymer.

36-37. (canceled)
